(19) United States
(12) Patent Application Publication
(10) Pub. No.: US 2011/0007071 A1
(43) Pub. Date: Jan. 13, 2011

(54) Method for Supporting Puncture Planning in a Puncture of an Examination Object

(76) Inventor: Marcus Pfister, Bubenreuth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/845,403

(22) Filed: Jul. 28, 2010

(30) Foreign Application Priority Data
Jul. 8, 2009 (DE) 10 2009 036 611.3

(51) Int. Cl. G06T 17/00; G06K 9/34

(52) U.S. Cl. 345/419; 382/128

(57) ABSTRACT

In order to enable improved and faster performance of punctures, a method is provided for technically supporting guidance to a target during a puncture of an examination object. A 3D data set of a body volume of the examination object that is to be treated is segmented. A puncture target is marked in the segmented 3D data set. The available puncture sites are assessed in terms of their suitability as insertion points on the basis of the information obtained through the segmentation.

### CROSS REFERENCE TO RELATED APPLICATIONS

This application claims priority of German application No. 10 2009 036 611.3 filed Aug. 07, 2009, which is incorporated by reference herein in its entirety.

### FIELD OF THE INVENTION

The invention relates to a method for supporting puncture planning in the case of a puncture of an examination object.

### BACKGROUND OF THE INVENTION

It is a long-established practice in the case of interventional procedures, hence also in the case of punctures, to record X-ray images, especially fluoroscopic images, as a supporting measure. The present invention relates in particular to the field of fluoroscopy-controlled percutaneous punctures (e.g. percutaneous transhepatic cholangiodrainage (PTCD)) performed with the aid of angiography systems (e.g. the Siemens Axiom ARTIS or zee systems).

Generally, before a puncture is performed, a 3D volume data set of the examination object that is to be treated and the afferent and efferent vessels is recorded (e.g. by means of DynaCT, CT, MR). The puncture can then be planned on said 3D data set, usually by marking the target point and insertion point (puncture site) and the corresponding overlay of the planned path in the 2D fluoroscopic image. A method of this kind is known from DE 10 2007 029 199, for example. The puncture path is typically planned in an MPR visualization of the volume (MPR =Multi-Plane Reconstruction; includes a plurality of slices through the volume from different sides). After puncture site and target point have been specified a manual investigation is then carried out to determine whether the planned path is likely to harm sensitive structures such as e.g. major vessels. If this is the case a new path must be planned and checked until such time as a safe path is found. In certain circumstances, in particular in the case of the puncture of targets lying deep in the tissue, this can culminate in a time-consuming “trial and error” procedure until a safe path has been found.

### SUMMARY OF THE INVENTION

It is the object of the present invention to provide a method which enables a faster, improved puncture that is safe for the examination object.

The object is achieved according to the invention by means of a method for supporting puncture planning in the case of a puncture as claimed in the independent claim. Advantageous embodiments of the invention are in each case the subject matter of the associated dependent claims.

The method according to the invention for supporting puncture planning in the case of a puncture of an examination object comprises the following steps of: segmenting a 3D data set of a body volume of the examination object that is to be treated, marking a puncture target in the segmented 3D data set, assessing the available puncture sites in terms of their suitability as insertion points based on the information obtained through the segmentation, and visualizing suitable puncture sites. By means of the method according to the invention a person performing a puncture, e.g. a physician, can very quickly and easily identify which puncture path is suitable for the actual puncture and in which a risk of injuries or else a general impassability is likely. As a result the performance of punctures will become considerably safer for the patient, easier for the physician and time will be saved compared with the known, protracted “trial and error” process; in particular it will be possible to dispense with time-consuming checks and replanning of puncture paths.

According to an embodiment of the invention a segmentation is performed with regard to bones and/or blood vessels (filled with contrast agent). Automatic and semi-automatic (with intervention by the operator) methods for performing such segmentations of 3D data sets are known from the prior art. Bones are particularly important for the performance of the puncture since these generally represent insurmountable obstacles for a puncture needle and blood vessels, since the accidental puncturing of the same can result in serious injuries to patients. For an even better and safer preparation for a puncture, a segmentation is advantageously performed with regard to further bodily structures, such as nerves and organs, for example. The segmented areas can then be assigned special information (not passable, conditionally passable, etc.), such that the assessment can subsequently refer to said information.

In order to complete puncture planning particularly quickly, at least the segmentation and/or the assessment are/is advantageously performed automatically. Image processing programs or special software can be used for this purpose, for example. Known image processing programs are available for segmenting 3D data sets and these can be modified as appropriate. Special planning support software that operates on the basis of the information obtained through the segmentation can easily be written for the purposes of the assessment. Starting from the puncture target, for example, the assessment can be performed on the basis of the direct connection between puncture site and puncture target and can include information about bones, vessels or other structures lying in the way.

According to another embodiment of the invention the assessed puncture sites are classified, i.e. assigned to different classes. The simplest assignment can consist, for example, in subdividing the assessed puncture sites into two classes (e.g. “suitable puncture sites” and “unsuitable puncture sites”). Three classes are a further possibility, for example “suitable puncture sites” (no bones, vessels or structures in the puncture path), “unsuitable puncture sites” (bones in the puncture path) and “conditionally suitable puncture sites” (vessels and structures in the puncture path). Other classifications can also be used.

According to another embodiment of the invention the classified puncture sites are visualized in accordance with their classification. This can be accomplished for example as a marker or colored indicator on a screen display, for example the MPR display frequently used for punctures. For example, a color marking scheme can represent suitable puncture sites as green, whereas unsuitable sites can displayed as yellow.

The 3D data set is advantageously recorded by means of an angiography X-ray system prior to the segmentation.

In this case an inventive image processing and computing unit for processing 3D data sets includes a program memory for storing program code, with program code that performs the method according to the invention being present in the program memory. Also claimed is a computer program product, comprising program code means of a computer program that are stored on a computer-readable data medium for the purpose of performing the method when the computer program is executed on a computer.

### BRIEF DESCRIPTION OF THE DRAWINGS

The invention and further advantageous embodiments according to features of the dependent claims are explained in more detail below with reference to exemplary embodiments schematically represented in the drawing, without this implying any restriction of the invention to said exemplary embodiments.

FIG. 1 shows a sequence of steps in the method according to the invention,

FIG. 2 shows a side view of an examination object with suitable and conditionally suitable areas for puncture sites displayed,

FIG. 3 shows an MPR view of an examination object provided for a puncture with suitable and conditionally suitable areas for puncture sites displayed, and

FIG. 4 shows an angiography system comprising an image processing and computing unit for performing the method.

### DETAILED DESCRIPTION OF THE INVENTION

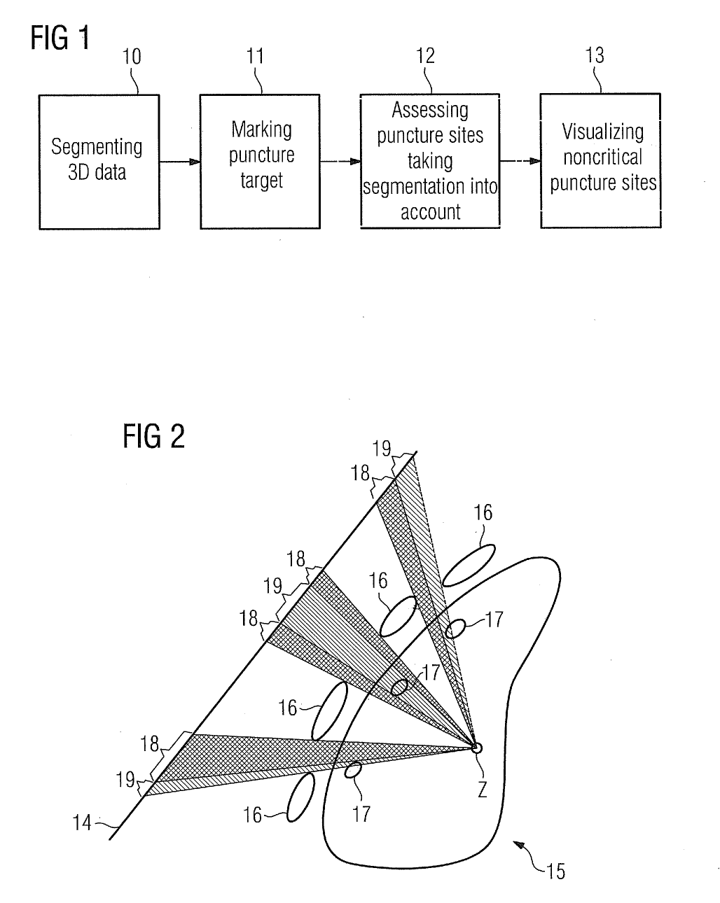

FIG. 1 shows a sequence of steps in the method according to the invention. In a first step 10, a previously recorded 3D data set of an examination object that is to be punctured is segmented, in particular with regard to structures such as bones or (major) blood vessels or other bodily structures such as nerves and organs. Such a segmentation can be performed automatically or semi-automatically, i.e. with the support of an operator. Information such as e.g. “impassable” or “conditionally impassable” can be assigned to the segments. Next, in a second step 11, the puncture target is marked in the now segmented 3D data set. This can be accomplished, for example, by means of an intervention by the operator in that, for example, the operator clicks on the volume image or other visual representation (e.g. MPR visualization) shown on a display unit and thereby specifies it.

In a third step 12, available puncture sites are then assessed in terms of their suitability, the information obtained through the segmentation being used for this purpose. This can in turn be perfumed automatically by means of planning software. First, all available puncture sites for the puncture target are calculated, for example by means of simple connecting lines from the puncture target to the (skin) surface of the examination object. The connecting lines present for the available puncture sites (that is to say, the theoretical puncture paths) are checked to determine whether they are cut and, if so, by which structures. This happens on the basis of the information obtained through the segmentation, according to which it is known where bones, vessels and/or other bodily structures are located. The associated puncture sites are classified according to their assessment on the basis of the segmentation information, in other words, for example, assigned to two or three or more classes.

An assessment can be performed as follows, for example: If the connecting line between puncture site and puncture target runs through an impassable structure such as a bone, i.e. if it is impossible for a puncture to be performed along said connecting line, then the corresponding puncture site is assigned to the class of “unsuitable” puncture sites. If the connecting line runs through a structure which, though passable, is critical, such as e.g. a blood vessel, a puncture using said puncture site, although it can be performed in principle, should nonetheless be checked again beforehand by an operator. The corresponding puncture site is assigned to the class of “conditionally suitable” puncture sites. If the connecting line runs through no sensitive or impassable structure at all, then a puncture can be performed. The corresponding puncture site is assigned to the class of “suitable” puncture sites.

Subsequently, in a fourth step 13, a visualization of suitable puncture sites is performed. This can be performed, for example, on the volume image displayed on a display unit or on an MPR visualization (usual in the case of puncture planning). The visualization can be displayed, for example, for all puncture sites or only for puncture sites marked by an operator. Colored indicators, such as e.g. traffic light indicators, can be used for this purpose, for example. Puncture sites that are not suitable can be represented, for example, by red, sites that are conditionally suitable by yellow, and suitable sites by green.

FIG. 2 shows an examination object 15 with suitable and conditionally suitable areas for puncture sites displayed. The examination object 15, for example, can be a patient or a part of a patient (e.g. torso). Bones 16 and blood vessels 17 are located in the interior of the examination object 15. All puncture sites present on the surface 14 of the examination object for a puncture target Z are calculated and assessed as well as classified. The double-hatched fans show suitable puncture sites 18 or, as the case may be, connecting lines and the single-hatched fans show conditionally suitable puncture sites 19 or, as the case may be, connecting lines.

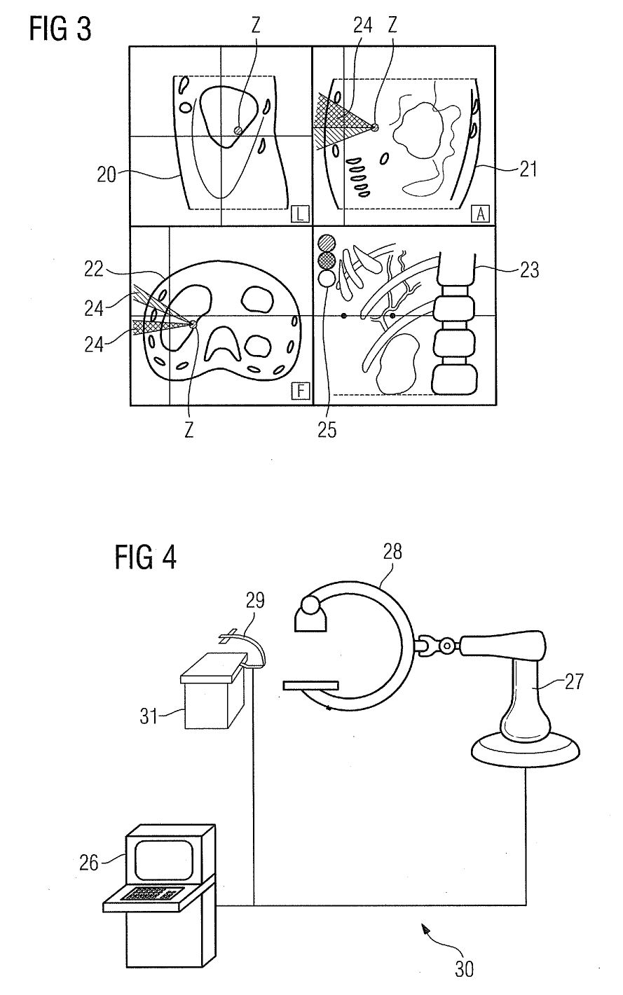

FIG. 3 shows a so-called MPR visualization on which an inventive visualization of suitable and conditionally suitable puncture sites is represented. The known. MPR visualization is composed e.g. of four displays, a first slice 20 (L=Left), a second slice 21 (A=Anterior), a third slice (F=Feet) and a 3D image 23 (e.g. containing the segmented areas). The crosshairs in each case show the positions of the other slices. Colored fans 24 for suitable, unsuitable, and/or conditionally suitable puncture sites can now be additionally superimposed on these displays. In the selection of puncture sites (e.g. by clicking or setting what is termed an MPR cross) the available puncture paths running toward the puncture target can also be superimposed as corresponding colored fans 24 for each current MPR slice. In this way an operator knows immediately which puncture paths or, as the case may be, puncture sites are suitable for the puncture and whether a risk exists for the examination object.

It can also be provided that e.g. the impassable puncture paths (that e.g. would run through a bone) are not superimposed at all or are superimposed as red fans. A further visualization option consists in overlaying a set of colored traffic lights 25, comprising the colors green, yellow and red, for example. When the operator places the MPR cross onto a possible puncture site, the superimposed traffic light 25 indicates whether the puncture is suitable or whether a blood vessel or a bone is located on the puncture path.

Further visualizations are possible, e.g. including the possibility that on principle the system does not accept unsuitable puncture sites at all.

In addition to the assessment of the puncture sites according to aspects of the body structure, separate boundary conditions can also be included, e.g. that certain puncture paths cannot be taken for technical reasons, because e.g. they would lead along the body axis or the angiography system cannot achieve the necessary angulations.

FIG. 4 shows an angiography X-ray system 30 which has an image processing and computing unit 26 that is suitable for performing the method according to the invention. For that purpose the image processing and computing unit 26 has one or more computer programs which can control the method according to the invention and by means of which e.g. the segmentation, the assessment and the visualization can be performed automatically. The angiography X-ray system 30 has an industrial robot 27 and a C-arm 28 having an X-ray source and an X-ray detector. By means of said components projection images of the examination object can be recorded by the angiography X-ray system 30. A 3D data set can be reconstructed from the projection images and visualized by means of the image processing and computing unit 26. The angiography X-ray system 30 can also be assigned a frame 29 for assisting with the needle alignment for a puncture.

The invention can be briefly summarized as follows: In order to enable improved and faster performance of punctures a method for supporting puncture planning in the case of a puncture of an examination object is provided, the method comprising the steps of segmenting a 3D data set of a body volume of the examination object that is to be treated, marking a puncture target in the segmented 3D data set, assessing the available puncture sites in terms of their suitability as insertion points on the basis of the information obtained through the segmentation, and visualizing suitable puncture sites.

The invention includes the pre-segmentation of a 3D data set used for planning a puncture and the utilization of the segmentation information for puncture planning. Since the possible puncture sites for a specific puncture target are immediately assessed and classified, a physician can see directly whether sensitive or impassable structures lie on the planned puncture path. This saves on time-consuming checking and replanning of puncture paths.

1-10. (canceled)

11. A method for supporting a puncture planning in a puncture of an examination object, comprising:
segmenting a 3D data set of a body volume of the examination object;
marking a puncture target in the segmented 3D data set;
assessing a puncture site as an insertion point for the puncture target; and
displaying the puncture site.

12. The method as claimed in claim 11, wherein the 3D data set is segmented with regard to a bone and/or a blood vessel of the examination object.

13. The method as claimed in claim 12, wherein the 3D data set is segmented with regard to a further body structure of the examination object.

14. The method as claimed in claim 13, wherein the further body structure comprises a nerve and an organ of the examination object.

15. The method as claimed in claim 11, wherein the 3D data set is segmented automatically.

16. The method as claimed in claim 11, wherein the puncture site is assessed automatically.

17. The method as claimed in claim 11, wherein the puncture site is classified.

18. The method as claimed in claim 17, wherein the puncture site is classified as a suitable puncture site, an unsuitable puncture site, or a conditional suitable puncture site.

19. The method as claimed in claim 17, wherein the classified puncture site is displayed according to the classification.

20. The method as claimed in claim 19, wherein the classified puncture site is displayed by a colored indicator.

21. The method as claimed in claim 11, wherein the 3D data set is recorded by an angiography X-ray system prior to the segmentation.

22. An image processing and computing unit for supporting a puncture planning in a puncture of an examination object, comprising:
a memory unit that stores a program code for:
segmenting a 3D data set of a body volume of the examination object,
marking a puncture target in the segmented 3D data set, and
assessing a puncture site as an insertion point for the puncture target; and
a display unit that displays the puncture site.

23. A computer program product stored on a computer-readable data medium and executable in a computer for supporting a puncture planning in a puncture of an examination object, comprising:
a program code for:
segmenting a 3D data set of a body volume of the examination object,
marking a puncture target in the segmented 3D data set, and
assessing a puncture site as an insertion point for the puncture target.
